(19) United States
(12) Patent Application Publication
(10) Pub. No.: US 2004/0059834 A1
(43) Pub. Date: Mar. 25, 2004

(54) Efficient exchange of text based protocol language information

(75) Inventors: Keith A. Taylor, Marietta, GA (US); Lee G. Friedman, Alpharetta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BellSouth Intellectual Property Corporation, Wilmington, DE

(21) Appl. No.: 10/247,453

(22) Filed: Sep. 19, 2002

(51) Int. Cl. G06F 15/16

(52) U.S. Cl. 709/247; 713/201

(57) ABSTRACT

Systems for an efficient exchange of text based protocol language information include a compressor for compressing text based protocol language information, and a decompressor for decompressing the compressed text based protocol language information. The compressed and decompressed text based protocol language information is transmitted between processors that are adapted to process text based protocol language information. The system may also include an encryption processor to encrypt the compressed text based protocol language before transmitting the compressed text based protocol language information. A decryption processor decrypts the encrypted and compressed text based protocol language information for use by the processors. Other systems and methods are also provided.

### TECHNICAL FIELD

The present invention is generally related to communications and, more particularly, is related to text based protocol languages.

### BACKGROUND OF THE INVENTION

There exists a growing popularity in the use of text based protocol languages such as, Hyper-Text Markup Language (HTML), Extensible Markup Language (XML), and other protocols, such as Session Initiated Protocols (SIP), Simple Network Management Protocol (SNMP), and Simple Object Access Protocol (SOAP), etc. for World Wide Web Pages, instant messaging, etc. Instant messaging services account for a portion of the increase in popularity of the use of text based protocol languages, in particular XML. Instant messaging is a type of communication that includes groups of members that communicate with each other via private chat transactions. The protocols typically include, routing between points within an Internet Protocol (IP) environment.

Text based protocol languages, such as HTML, typically define a structure and layout of documents on the World Wide Web (“Web”) and/or the Internet, as examples, among others. Typically, the structure includes the use of tags and attributes. Tags are commands inserted in documents that specify how the documents or portions of the documents should be formatted. Many format specifications that store documents as text files utilize tags. Often, the text information is included between special header and footer tags. On a typical Web page, for example, hundreds of tags may be used to format information displayed on the Web page.

XML provides a mechanism for describing information. Unlike with HTML, developers can also define their own tags and document structure using XML. Once a tag is created in XML, associated programs are utilized to send, receive and display the tags. Tags can be nested within each other, i.e., a tag within a tag, within a tag, etc. Thus, as more members subscribe to instant messaging services. For example, the number of tags being communicated will continue to grow. The growth in tags is utilizing more network bandwidth. Moreover, because of redundant tag information sent across the network, the current methods utilized to send tags is an inefficient manner in which to transport streams of information across a network.

Thus, a heretofore-unaddressed need exists for a solution that addresses the aforementioned deficiencies and inadequacies.

### SUMMARY OF THE INVENTION

The preferred embodiments of the present invention provide systems and methods for efficient exchange of text based protocol language information.

Briefly described, in architecture, one preferred embodiment of the system, among others, can be implemented as follows. A system for an efficient exchange of text based protocol language information includes a compressor for compressing text based protocol language information, and a decompressor for decompressing the compressed text based protocol language information. The compressed and decompressed text based protocol language information is transmitted between processors that are adapted to process text based protocol language information. In an alternative preferred embodiment, the system includes an encryption processor to encrypt the compressed text based protocol language before transmitting the compressed text based protocol language information. A decryption processor decrypts the encrypted and compressed text based protocol language information for use by the processors.

One preferred embodiment of the present invention can also be viewed as providing methods for efficient text based protocol language exchanges. In this regard, one embodiment of such a method, among others, can be broadly summarized by the following steps: compressing text based protocol language data streams, forwarding the compressed text based protocol language data streams, receiving the compressed text based protocol language data streams, and decompressing the compressed text based protocol language data streams for use by the processors.

Other systems, methods, features, and advantages of the present invention will be or become apparent to one with skill in the art upon examination of the following drawings and detailed description. It is intended that all such additional systems, methods, features, and advantages be included within this description, and be within the scope of the present invention.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram depicting a preferred embodiment of an environment in which an efficient exchange of text based protocol language information system may be implemented.

FIG. 2 is a block diagram depicting a preferred embodiment of an illustrative example of a compressor/decompressor (CODEC) of the efficient exchange of text based protocol language information system of FIG. 1.

FIG. 3 is an illustrative example of extensible markup language (XML) information.

FIG. 4 is a block diagram depicting a computer or processor-based system that can be used to implement a preferred embodiment of an efficient exchange of text based protocol language information system.

FIG. 5 is a block diagram depicting a preferred embodiment of an illustrative example of a table of commands and associated compression of the commands.

FIG. 6 is a block diagram depicting a preferred embodiment of a system for implementing an efficient exchange of text based protocol language information system including an encryption/decryption system.

FIG. 7 is a flow chart depicting functionality of a preferred embodiment of an implementation of efficient exchange of text based protocol language information system.

### DETAILED DESCRIPTION OF THE PREFERRED EMBODIMENTS

Disclosed herein are systems and methods for an efficient exchange of text based protocol language information. To facilitate description of the inventive system, an example system that can be used to implement the systems and methods for an efficient exchange of text based protocol language information is discussed with reference to the figures. Although this system is described in detail, it will be appreciated that this system is provided for purposes of illustration only and that various modifications are feasible without departing from the inventive concept. After the example system has been described, an example of the operation of the system will be provided to explain the manner in which the system can be used to provide an efficient exchange of text based protocol language information.

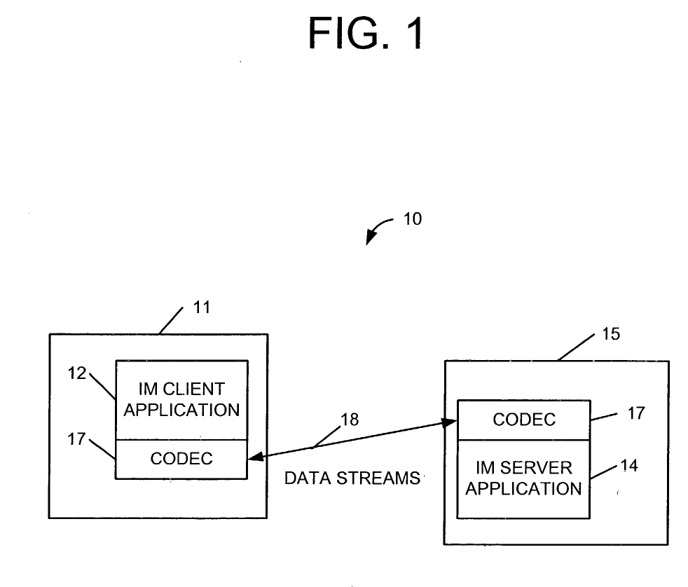

Referring now in more detail to the drawings, in which like numerals indicate corresponding parts throughout the several views, FIG. 1 is a block diagram depicting a preferred embodiment of a system 10 in which an efficient exchange of text based protocol language information system may be implemented. One preferred embodiment of the system 10 includes processing devices such as a client 11 and server 15. An alternative preferred embodiment, the processing devices of the system 10 include two servers. In one preferred embodiment the client 11 includes a client application 12. Suitable client applications 12 include, among others, Instant messaging service client applications, such as AOL Instant Messenger™ or Jabber Instant Messenger™. In a preferred embodiment, the server 15 provides a service of a service provider through a server application 14, for instance, AOL Instant Messaging™ service application, among others. The client application 12 is operatively coupled to a compressor/decompressor (“CODEC”) 17. The client CODEC 17 compresses data streams 18 sent to the server 15. In other embodiments, the CODEC 17 includes one-way compressing/decompressing, such as with Web pages or other instant messaging systems, etc., where there is no need for sending upstream in a markup language. In a preferred embodiment, the data streams 18 are sent over a communications network. The communications network may be any type of communications network employing any network topology, transmission medium, or network protocol. For example, such a network may be any public or private packet-switched or other data network, including the Internet, circuit-switched network, such as a public switch telecommunications network (PSTN), wireless network, or any other desired communications infrastructure and/or combination of infrastructure. In one preferred embodiment, the communications network utilizes a Transmission Control Protocol Internet Protocol (TCP/IP) transmission to send the data streams 18. In a preferred embodiment, the data streams 18 exchange compressed text based language information, for instance XML. The receiving server 15 has a CODEC 17. In one embodiment, the CODEC 17 couples to an instant messaging server application 14. The CODEC 17 decompresses the compressed data stream 18 before the instant messaging server application 14 processes the data stream 18 using its normal processing methods.

The system 10 in which an efficient exchange of text based protocol language information system may be implemented provides for utilizing the basic structure of these markup languages, for instance, tags. The tags contain a large amount of redundant data, which can be stripped off in a compression process and reinstated during the decompression process.

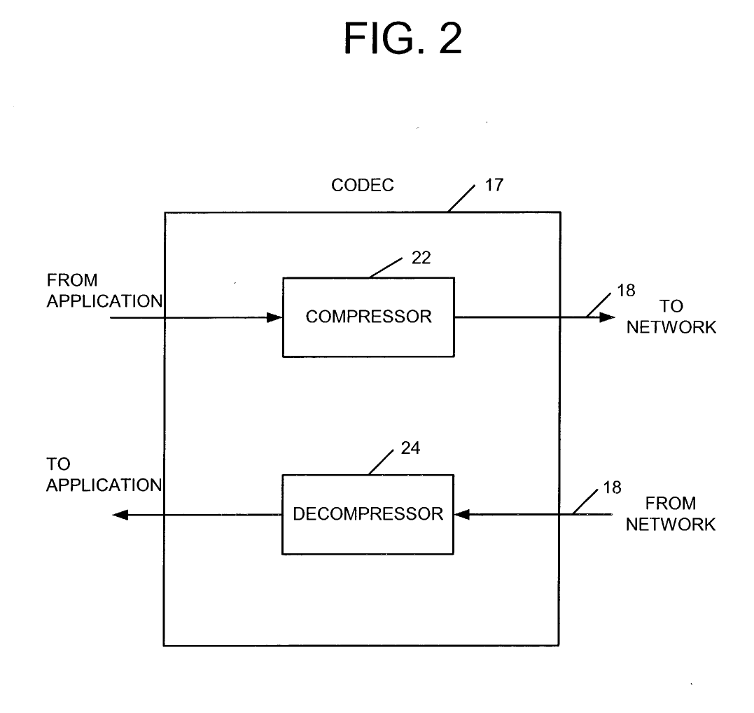

FIG. 2 is a block diagram depicting an illustrative example of the CODEC 17 of the efficient exchange of text based protocol language information system 10 of FIG. 1. In a preferred embodiment, the CODEC 17 includes a compressor 22 and a decompressor 24. Preferably, the compressor 22 compresses information from an application, such as instant messaging, and forwards the compressed data stream 18 to the communications network. A compressed data stream 18 from the communications network enters the decompressor 24. The decompressor 24 decompresses the compressed data stream 18 being used by the application.

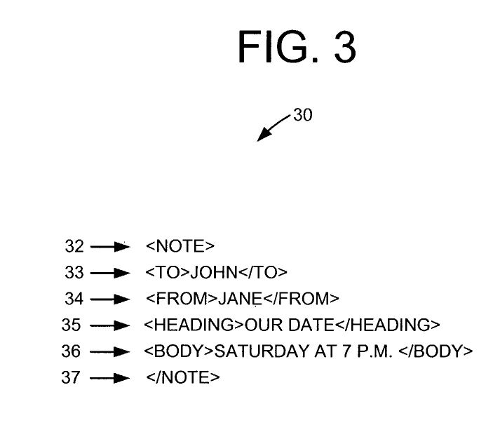

FIG. 3 is an illustrative example 30 of an extensible markup language (XML) information, including tags and text. The information of FIG. 3 is a note from Jane to John. Line 32 includes a <note> tag that describes the root element of the document, i.e., that the document is a note. Line 33, describes the first child element of the root, i.e., that the note is “to” someone. Further, line 33 contains three segments, for example, “<to >” is the beginning of the element, “John” is the person to receive the note, and “</to >” defines the end of the element. Line 34 describes the second child element of the root. The first segment of line 34 contains the “<from>” indicating the beginning of the element, “Jane” as the person sending the note, and “</from>” which defines the end of the element. Line 35 describes the third child element of the root. The first segment of line 35 contains the “<heading>” indicating this is a heading of the note, “Our Date” indicating the note is about their date, and “</heading>” which defines the end of the element. Line 36 describes the fourth child element of the root and gets to the body of the message. The first segment of line 36 contains the “<body>” indicating the body of the text for the note will follow. “Saturday at 7 p.m.” indicates that the date between Jane and John, will take place Saturday at 7 p.m., and “</body>” which defines the end of the element for this line. Line 37 defines the end of the root element by “</note>”.

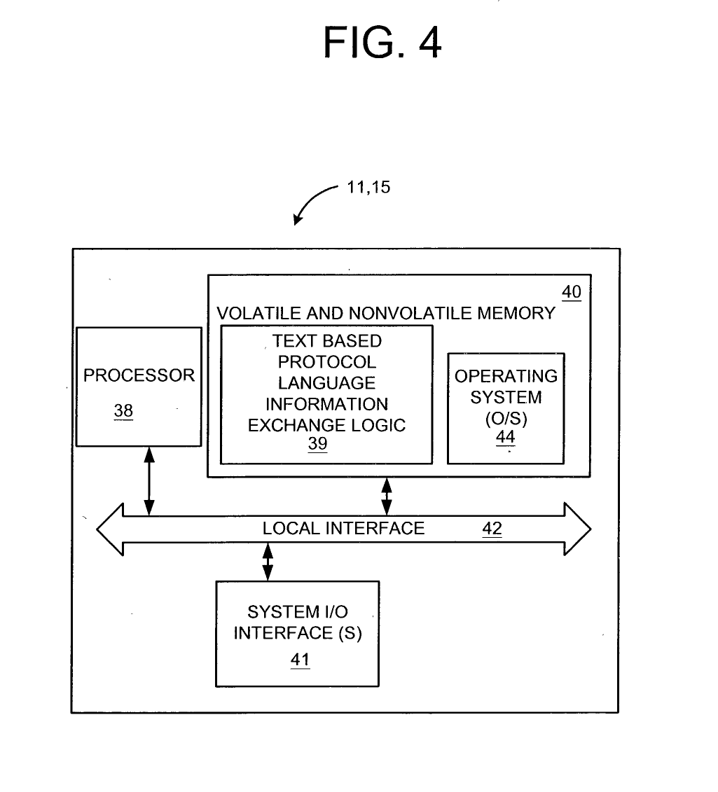

FIG. 4 is a block diagram depicting processing devices 11, 15 that can be used to implement a preferred embodiment of an efficient exchange of text based protocol language information system. As shown in FIG. 4, text based protocol language information exchange logic 39 that can be utilized as logic for CODEC 17 and can be implemented in software (e.g., programming stored on a medium, firmware, etc.), hardware, or a combination thereof. In the preferred embodiments, the logic 39 is implemented in software as an executable program, and is executed by a special or general purpose digital computer, such as a personal computer (PC; IBM-compatible, Apple-compatible, or otherwise), workstation, minicomputer, or mainframe computer.

Generally, in terms of hardware architecture, the processing devices 11, 15 include, inter alia, a processor 38 and memory 40. Input and/or output (I/O) devices 41 (or peripherals) can be communicatively coupled to a local interface 42. The local interface 42 can be, for example but not limited to, one or more buses or other wired or wireless connections, as is known in the art. The local interface 42 may have additional elements, which are omitted for simplicity, such as controllers, buffers (caches), drivers, repeaters, and receivers, to enable communications. Further, the local interface 42 may include address, control, and/or data connections to enable appropriate communications among the aforementioned components.

The processor 38 is preferably a hardware device for executing software, particularly that stored in memory 40. The processor 38 can preferably be any custom made or commercially available processor, a central processing unit (CPU), an auxiliary processor among several processors, a semiconductor based microprocessor (in the form of a microchip or chip set), a macroprocessor, or generally any device for executing software instructions.

The memory 40 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 40 may incorporate electronic, magnetic, optical, and/or other types of storage media. Note that the memory 40 can have a distributed architecture, where various components are situated remote from one another, but can be accessed by the processor 38.

The software and/or firmware in memory 40 may include one or more separate programs, each of which comprises an ordered listing of executable instructions for implementing logical functions. In the example of FIG. 4, the software in the memory 40 includes the logic 39 and a suitable operating system (O/S) 44. The operating system 44 essentially controls the execution of other computer programs, such as the logic 39, and provides scheduling, input-output control, file and data management, memory management, and communication control and related services.

The logic 39 is preferably a source program, executable program (object code), script, or any other entity comprising a set of instructions to be performed. When the logic 39 is implemented as a source program, then the program needs to be translated via a compiler, assembler, interpreter, or the like, which may or may not be included within the memory 40, so as to operate properly in connection with the O/S 44. Furthermore, the logic 39 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The I/O devices 41 may preferably include input devices, for example but not limited to, a keyboard, mouse, scanner, microphone, etc. Furthermore, the I/O devices 40 may also include output devices, for example but not limited to, a printer, display, etc. Finally, the 1/0 devices 41 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

When the logic 39 is implemented in software, as is shown in FIG. 4, it should be noted that the logic 39 can preferably be stored on any computer-readable medium for use by or in connection with any computer related system or method. The logic 39 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. If implemented in hardware, as in an alternative embodiment, the logic 39 can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

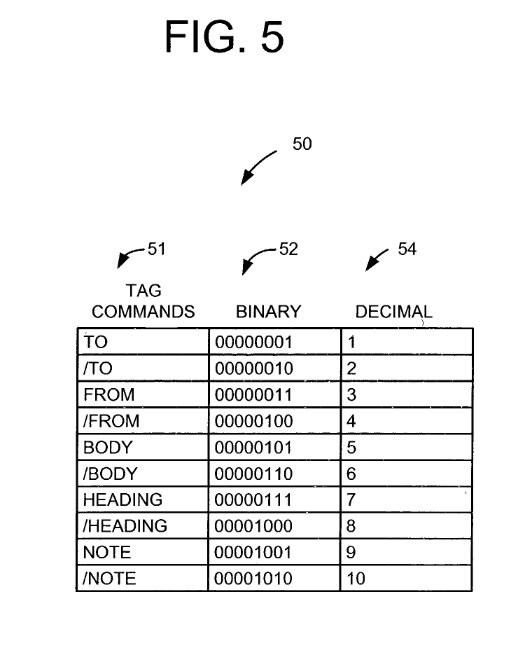

FIG. 5 is a block diagram depicting a preferred embodiment of an illustrative example of a table 50 of tag commands and associated compression of selective tag commands utilized in the illustrative example 30 of FIG. 3. The compressing and decompressing is performed by the CODEC 17. Tag commands typically include redundant information. Services utilizing text based protocol languages include a large number of tag commands, and thus, by selecting tag commands to compress and decompress commands that occur most frequently, the process of exchanging text can be optimized. For instance, if the total number of discrete tag commands are known, then in a preferred embodiment, the total number of compressed commands is 2ⁿ, where n equals the number of discrete commands. In a preferred embodiment, 2ⁿ is the total number of bits needed as code per service.

Tests or some other determination is made to determine which commands occur most frequently. The commands that are determined to occur the most frequently may also be chosen to correspond to codes with the smallest values, i.e., the codes with larger numbers of significant zeros. Consequently, compression of those codes provides for a more efficient compression of the overall tag commands. A suitable compression technique that can be utilized in this invention is a Canonical Huffman technique, however this invention is not limited to this compression technique. Thus, the CODEC 17 in one preferred embodiment compress the tags, though the compression step does not occur in all embodiments. For instance, data that is already encoded using for instance, a .JPEG format, can be transmitted using the system of one preferred embodiment of the invention without further compression.

Referring to the table 50 in FIG. 5, tag commands 51 are listed with the associated compressed binary and its equivalent decimal unit. The compression shown in FIG. 5 is for illustrative purposes only, and this invention is not limited to the techniques shown in FIG. 5. The first tag command (shown in the first line of the table) is “TO”. The “TO” utilized here is simply for illustrative purposes and it is likely that other commands may be most common throughout the message For example, a <p> commands may be more likely to be most common or a font tag, among others. As shown in line 33 of FIG. 3, the complete tag for this command is “<TO>”. The beginning (“<”) and ending (“>”) markers are omitted during compression since they are implied with every tag. The elimination of the beginning and ending markers serves to reduce the tag data units by two. The commands can be compressed into bit, bytes or other binary representation. For example, the command “TO” has been compressed to binary representation 000000001, which equals the decimal equivalent of 1. Thus, a tag requiring 4 data units, (i.e., <=1, T=2, 0=3, and >=4) upon compression, can be represented by 1 data unit. FIG. 5 shows compression for other tag commands of FIG. 3. In a preferred embodiment, the text, e.g., “Our Date” shown in line 35 of FIG. 3, as well as its tags can be compressed using compression techniques such as the compression technique shown in FIG. 5.

In an alternative embodiment, the text can be compressed using a compression technique that compresses based upon the most often used letter. For example, the letter “e” is typically used most often in text. Thus, the letter “e” may be compressed and represented by 1, which equals one bit. If the letter “a” is the next most utilized letter in text, the letter “a” can be compressed and represented by 10 which represents two bits. Compression using these techniques would continue until the text is compressed into bits, bytes, or other binary representation that represent the smaller set of codes that depict the text based protocol language.

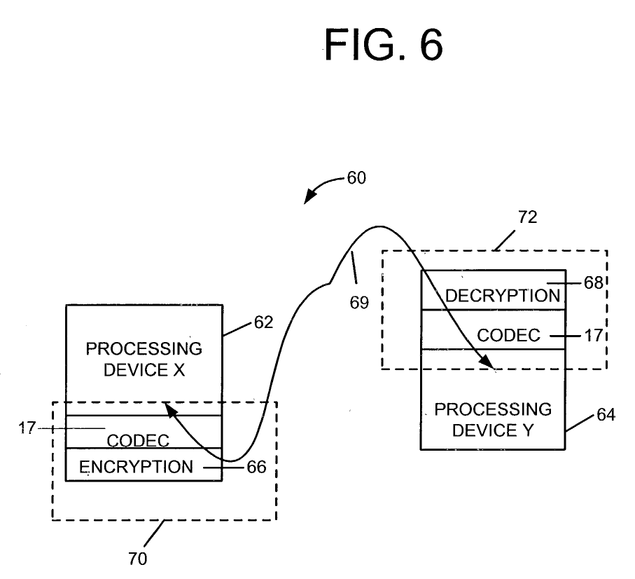

FIG. 6 is a block diagram depicting a preferred embodiment of a system 60 for implementing an efficient exchange of text based protocol language information system including encryption and decryption processors 66, 68. As shown in FIG. 6, processing device (or service) X 62 communicates with processing device (or service) Y 64. In a preferred embodiment, processing device X 62 is adapted to process an instant messaging client application, and processing device Y 64 is adapted to process an instant messaging service. In another preferred embodiment, processing device X 62 and processing device Y 64 are servers, running a text based protocol language service. At processing device X 62, CODEC 17 is coupled to an encryption processor 66. The text based protocol language is thereby compressed by CODEC 17 and encrypted by the encryption processor 66 and transmitted by, for example, a Transmission Control Protocol Internet Protocol (TCP/IP) transmission 69, to the decryption processor 68. The decryption processor 68 decrypts the encrypted message and the CODEC 17 decompresses the message. Processing device Y 64 processes the decrypted and decompressed text based protocol language message.

In a preferred embodiment, the encryption processor 66 and decryption processor 68 utilize encryption technologies such as a Secure Socket Layer (SSL) technology available from Netscape Communications Corporation. The SSL security protocol can include a cryptographic key and provides data encryption, server authentication, message integrity, and client authentication for a TCP/IP connection, among others. In an alternative preferred embodiment, the CODEC 17 and encryption processor 66 and the CODEC 17 and decryption processor 68 are each combined into a system 70, 79 and offered as a service available to processing device X 62 and processing device Y 64.

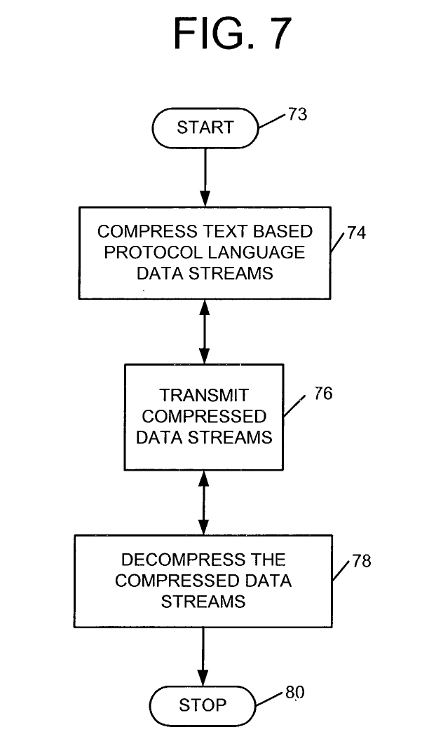

FIG. 7 is a flow chart depicting functionality (or method) of a preferred embodiment of an implementation of an efficient exchange of text based protocol language information system. The process begins at 73. At 74, the text based protocol language is compressed into data streams. In a preferred embodiment, the compression process involves optimizing the commands by replacing the commands with a smaller set of codes that represent the commands. For instance the command can be reduced to a bit, byte or other binary representation of the command, such as the command example shown in FIG. 5. The invention is not limited to this compression process and other suitable compression techniques may be utilized with this invention.

The compressed data streams are transmitted at 76. In a preferred embodiment, the compressed data streams are transmitted utilizing TCP/IP. In an alternative preferred embodiment, the compressed data streams are encrypted prior to being transmitted. At 78, the compressed data streams are decompressed. In a preferred embodiment, if the compressed data streams have been encrypted, they are decrypted prior to being decompressed. The process ends at 80.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may he executed out of order from that shown or discussed, including substantially concurrently or in reverse order, depending on the functionality involved, as would be understood by those reasonably skilled in the art of the present invention.

Preferred embodiments of the present invention provide for compressing and decompressing data without affecting communicating processors, and for reducing overhead by transmitting smaller, compressed data packets and increasing system throughput. In another preferred embodiment of the present invention provides for compressing and decompressing methods that are transparent to the sender and receiver of the data, with a nominal impact on service.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A system for an efficient exchange of text based protocol language information, comprising:
a compressor for compressing text based protocol language information; and
a decompressor for decompressing the compressed text based protocol language information, and wherein the compressed and decompressed text based protocol language information is transmitted between a plurality of processors that are adapted to process text based protocol language information.

2. The system of claim 1, wherein the text based protocol language information comprises any text based protocol language information transmitted over a network adapted to provide services such as instant messaging, web pages or transaction services.

3. The system of claim 1, wherein the text based protocol language information includes tags or text.

4. The system of claim 1, wherein the text based protocol language information comprises a markup language.

5. The system of claim 4, wherein the markup language is configured utilizing tags having at least one of an element, root element, body, or beginning or ending tag indications.

6. The system of claim 5, wherein the tags include commands that are converted to a code that represents the commands.

7. The system of claim 6, wherein the compressor is configured to compress the commands into bytes, bits or other binary representation.

8. The system of claim 6, wherein the compressor is configured to compress the commands using a compression process such as a Canonical-Huffman coding process.

9. The system of claim 1, further comprising an encryption processor for encrypting the compressed text based protocol language information before transmitting the compressed text based protocol language and a decryption processor for decrypting the compressed and encrypted text based protocol language information.

10. The system of claim 9, wherein the encryption and decryption processors are configured using encryption such as encryption provided by Secure Socket Layer (SSL) cryptographic processors.

11. A method for an efficient exchange of text based protocol language information, comprising the steps of:
compressing text based protocol language data streams;
forwarding the compressed text based protocol language data streams to processors adapted to support a text based language protocol service; and
decompressing the compressed text based protocol language data streams for use by the processors.

12. The method of claim 11, wherein the compressing text based protocol language data streams further comprises converting the text based protocol languages data streams to a smaller set of codes that represent the text based protocol language data streams.

13. The method of claim 12, wherein the converting the text based protocol languages data streams to a smaller set of codes that represent the text based protocol language data streams is performed on a markup language.

14. The method of claim 13, wherein the converting the text based protocol languages data streams to a smaller set of codes that represent the text based protocol language data streams is performed on at least one of tags or text of the markup language.

15. The method of claim 11, further comprising encrypting the compressed text based protocol language data streams.

16. The method of claim 15, further comprising decrypting the encrypted and compressed text based protocol language data streams.

17. The method of claim 11, further comprises providing encryption and decryption for the text based protocol language data streams using an encryption method such as encryption performed using Single Socket Layer (SSL) cryptographic processors.

18. A system for efficiently exchanging text based protocol languages, comprising:
a first processing device adapted to process a text based protocol language application;
a second processing device, the second processing device is operatively coupled to the first processing device and adapted to receive and service the text based protocol language application; and
a processor coupled to the first processing device and the second processing device, the processor adapted to compress and decompress commands of the text based protocol language application.

19. The system of claim 18, wherein the first processing device and second processing device are configured to support at least one service such as an instant messaging service, Web page or transaction service.

20. The system of claim 18, wherein the text based protocol language application comprises a markup language application.

21. The system of claim 18, wherein the commands comprise tags.

22. The system of claim 18, further comprising an encryption processor operatively coupled to the first processing device for encrypting the text based protocol languages before transmitting the text based protocol language application to the second processing device.

23. The system of claim 22, further comprising a decryption processor operatively coupled to the second processing device for decrypting the encrypted and compressed text based protocol language application.

24. The system of claim 18, wherein the first processing device is configured to encrypt the text based protocol language application upon exiting the first processing device and the second processing device is configured to decrypt the encrypted text based protocol language application before the second processing device services the text based protocol language application.

25. A system for efficiently exchanging text based protocol languages, comprising:
means for compressing text based protocol language information; and
means for decompressing the compressed text based protocol language information, and wherein the compressed and decompressed text based protocol language information is transmitted between a plurality of processors that are adapted to process text based protocol language.

26. The system of claim 25, further comprising means for encrypting the text based protocol language information before transmitting the compressed text based protocol language information and means for decrypting the encrypted and compressed text based protocol language information.

27. A computer-readable medium having a computer program for efficiently exchanging text based protocol languages, comprising:
logic configured to compress text based protocol language data streams;
logic configured to forward the compressed text based protocol language data streams to at least one processor adapted to support a text based language protocol application; and
logic configured to decompress the compressed text based protocol language data streams for use by the at least one processor.

28. The computer-readable medium of claim 27, further comprising logic configured to encrypt the compressed text based protocol language data streams.

29. The computer-readable medium of claim 28, further comprising logic configured to decrypt the encrypted and compressed text based protocol language data streams.
